(19) United States
(12) Patent Application Publication
(10) Pub. No.: US 2026/0070017 A1
(43) Pub. Date: Mar. 12, 2026

(54) HYDROXYCHLORIDE SALT OCEAN ALKALINITY ENHANCEMENT

(71) Applicant: MAGRATHEA METALS INC., San Francisco, CA (US)

(72) Inventors: Alexander GRANT, San Francisco, CA (US); Jacob BROWN, San Francisco, CA (US)

(21) Appl. No.: 19/104,550

(22) PCT Filed: Aug. 17, 2023
(86) PCT No.: PCT/US2023/072358

§ 371 Date: Feb. 18, 2025

Related U.S. Application Data
(60) Provisional application No. 63/399,443, filed on Aug. 19, 2022.

(51) Int. Cl. B01D 53/62; B01D 53/14; B01D 53/80

(52) U.S. Cl. CPC B01D 53/62; B01D 53/1475; B01D 53/1493; B01D 53/80; B01D 2251/402; B01D 2251/602; B01D 2251/604; B01D 2252/1035; B01D 2257/504; B01D 2258/0283

(57) ABSTRACT

The present technology provides for devices, methods, compositions, and systems for the environmentally friendly production of alkalinity units in ocean water for facilitating carbon sequestration.

### FIELD OF TECHNOLOGY

The present technology provides for devices, methods, compositions, and systems for environmentally friendly production of alkalinity units in ocean water for facilitating carbon sequestration.

### BACKGROUND

It is believed that carbon dioxide capture and sequestration technologies will be necessary to mitigate or reduce the concentration of carbon dioxide in the atmosphere since many industrial processes are difficult or impossible to decarbonize.

At the same time, ocean acidification has been identified as a concurrent problem of anthropogenic carbon dioxide emissions. Since the start of the industrial age, it has been estimated that the pH of the world's oceans has dropped by 0.1 pH unit, representing a 30% increase in the hydrogen cation concentration as expressed on a linear scale. This rise in acidity has been demonstrated to have detrimental impacts on ocean life. Thus, there is considerable interest in both mitigating ocean acidification and promoting carbon sequestration, especially without the involvement of terrestrial mineral mining.

The production of salt and potash results in waste bitterns, sometimes called “reject brines”, that need to be safely disposed of. These bitterns are produced by the evaporation of source brines, collection of the relatively insoluble salts, and optionally, treatment with other minerals, such as, but not limited to calcium oxide. They often contain significant leftover concentrations of Mg²⁺ and Cl⁻ and may be useful for alkalinity unit production. In some cases, naturally occurring and synthetic brines have high Mg²⁺ and Cl⁻ concentrations and can be used for alkalinity unit production as well. Table I shows a comparison of the compositions between seawater, and a brine and bittern derived from a chlor-alkali process plant. All three of these compositions are possible source brines for the processes of the present technology.

TABLE 1
Exemplary typical of seawater, brines and bitterns

| Property | Seawater | Brine | Bittern |
|---|---|---|---|
| Specific Gravity | 1.03 | 1.22 | 1.24 |
| pH | 8.15 | 7.13 | 6.95 |
| Baum'e | 3.5 | 25.5 | 28.5 |
| Na (ppm) | 10880 | 102890 | 77890 |
| K (ppm) | 394 | 3560 | 7630 |
| Ca (ppm | 423 | 340 | 150 |
| Mg (ppm) | 1311 | 11910 | 31740 |
| Cl (ppm) | 19655 | 185500 | 191160 |
| Sulfate (ppm) | 2742 | 16730 | 43230 |

The buffering characteristics of bitterns have been investigated in the course of studying changes in pH during the processing of certain brines into bitterns (Bodine, M. W. Jr.; Geology (1974) 4 (2): 76-80), incorporated herein in its entirety by reference. It was noted that the pH of the bitterns decreases as they evaporate. Surprisingly, we have discovered energy efficient processes to increase the rate of the reactions leading to this pH decrease and at the same time separate the components produced by the disproportionation reactions happening in these bitterns into basic and acidic fractions. The basic fractions comprising alkalinity units that can be introduced into seas and oceans and acidic components that are economically valuable. These processes are advantageous because these bitterns are normally considered waste products that require expensive disposal methods.

Processes using magnesium chloride for carbon sequestration have been described. U.S. Pat. No. 10,583,394, incorporated herein in its entirety by reference, discloses a carbon dioxide sequestration process comprising reacting magnesium chloride with steam to produce an admixture of magnesium hydroxychloride and hydrogen chloride and subsequently reacting the magnesium hydroxychloride with steam to produce magnesium hydroxide and hydrogen chloride, the magnesium hydroxide then being used as a carbon dioxide sequestering agent in combination with calcium chloride and steam to produce calcium carbonate and magnesium chloride. One drawback with such processes is that they are energy intensive.

U.S. Pat. No. 11,326,188, incorporated herein in its entirety by reference, discloses a process for the production of magnesium oxide and hydrogen chloride from solid magnesium chloride by a process of thermohydrolysis, where the magnesium chloride solid comprises at least 60% magnesium chloride tetrahydrate and preferably less than 30% magnesium chloride hexahydrate by drying magnesium chloride containing solutions at temperatures between 100° C. and 160° C. Such processes require that input streams have narrow composition limits and the process conditions have narrow operating parameter windows.

Approaches to increasing ocean alkalinity have been reviewed. Renforth describes a number of carbon dioxide sequestration strategies comprising adding alkalinity elevating substances to ocean waters in order to increase the rate of formation of carbonate and bicarbonate from atmospheric carbon dioxide in ocean water. (Renforth, P., & Henderson, G. (2017), incorporated herein in it entirety by reference). Assessing ocean alkalinity for carbon sequestration. Reviews of Geophysics, 55 (3), 636-674. https://doi.org/10.1002/2016RG000533.

However, the processes described in the above two references are energy intensive and, in some cases, involve the mining of minerals from the earth's crust with their concomitant social and environmental impacts.

There is thus a need in the field for processes that alleviate at least some of the above-mentioned drawbacks.

### SUMMARY

Ultimately, the efficiency of the process to provide alkalinity units for sea and ocean deacidification and carbon sequestration is dependent on the quantity of alkalinity units produced versus several parameters. These parameters include, but are not limited to, energy input, costs of starting material inputs, depreciation of capital assets, transportation, commercial sale value of side streams, revenues from the provision of disposal services of some inputs, and the creation of positive or negative production externalities typically monetized as the sale or trade of various carbon credits. The process of the present technology presents advantages in one or more of these considerations.

Herein, is disclosed a process for the energy efficient and environmentally friendly production of alkalinity units suitable for increasing the alkalinity and carbon sequestration capacity of seas and oceans. In other instances, these alkalinity units may be used to mitigate the environmental impact of industrial waste streams. In some cases, the processes of the present technology produces commercially valuable side streams that can be used to offset the costs of the environmental mitigation effects, or even in some cases make the processes economically valuable even not taking into account the potential values of various carbon credits that can be claimed by the operators due to the mitigation effects.

Surprisingly, the present investigators have found that a wide variety of magnesium chloride containing liquid sources, herein referred to as “source brines”, can be energy efficiently and environmentally benignly, processed to provide for hydrogen chloride depleted compositions which can be introduced into seas and oceans to increase their alkalinity. This increase in alkalinity may both mitigate the adverse effects of acidification on sea and ocean ecosystems, as well as increase the carbon sequestration capacity of those bodies of water. Additionally, the processes of the present technology may furnish valuable side stream products such as hydrochloric acid and high purity magnesium chloride.

Certain alkali earth metal salts undergo a process that is referred to as thermohydrolysis. As used herein, the term “thermohydrolysis” refers to the process where alkali earth metal halides such as, but not limited to magnesium chloride and calcium chloride, react with water to liberate the corresponding hydrogen halide to yield a solid, solution, or slurry that possess a neutralizing activity towards acids, hence providing compositions that provide alkalinity units. While the term “thermohydrolysis” generally refers to such a process that is conducted at an elevated temperature with respect to room temperature, depending on the starting composition and pressure, useful rates of reactions may occur even at temperatures below room temperature. It should be noted that if short reaction times are not required, conducting thermohydrolysis processes at relatively low temperatures is advantageous in terms of the required energy inputs.

This process can be illustrated with the following set of equations for the thermohydrolysis of aqueous composition comprising magnesium chloride and possible subsequent reactions. These compositions can be aqueous solutions, or compositions comprising solid magnesium chloride hydrates, since at some temperatures, solid magnesium chloride hydrates can change phase, yielding what are essentially aqueous, albeit, concentrated, solutions:

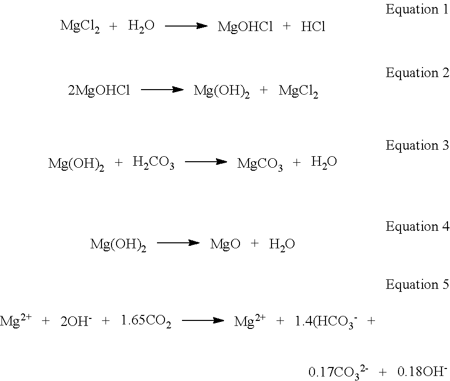

Equation 1 shows the first step of thermohydrolysis where magnesium chloride, for example, reacts with water to form magnesium hydroxychloride and hydrogen chloride. Here, the water may be supplied by providing water, or an aqueous solvent, or in the case of a solid starting composition, the water of hydration of one or more of the components serves as the water source. Equation 2 shows the second possible step of the thermohydrolysis where the magnesium hydroxychloride formed in the first step disproportionates into magnesium chloride and magnesium hydroxide. Equation 3 shows how the liberated magnesium hydroxide can act as a source of alkalinity units and as a carbon sequestration agent. Equation 4 shows a second possible path for magnesium hydroxide to disproportionate into magnesium oxide and water.

The overall equation for the carbon dioxide sequestration, taking into account the equilibration of bicarbonate, carbonate and hydroxide at pH 8.1 and 20 deg. C. is shown in equation 5, and may be used to estimate the amount of carbon dioxide induced to be sequestered by the addition of a given amount of magnesium hydroxide to a body of water. Since magnesium oxide hydrates to the hydroxide upon contact with water, this equation may also be used for estimating the sequestration effect for the addition of magnesium oxide to bodies of water as well. Equation 5 can be used to calculate the number of carbon credits that can be claimed or sold based on the composition of the alkalinity units produced by the processes described herein and the particular definition of the carbon unit to be claimed or sold.

Table 2 shows the known phases of magnesium hydroxychloride which may be obtained by the processes described herein, either in an isolated form, or as part of a more complex composition. Typically, these compositions comprising magnesium hydroxychloride may be made by mixing specific ratios of aqueous solutions of magnesium chloride and solid magnesium hydroxide or magnesium oxide, or process sequences or parameters may be adjusted to give the desired final composition directly. Here, the compositions comprising magnesium hydroxychloride may be made directly from source brines, reducing the energy input and process complexity associated with previous methods.

TABLE 2
Empirical Formulas of Stable Phases
of Magnesium Hydroxychorides

| | | Lower Hydrates and Phase |
|---|---|---|
| Phase | Empirical Formula | Change Initiation Temp. |
| 1 | Mg₃(OH)₄Cl₂•4H₂O | |
| 2 | 2Mg₂(OH)₃Cl•4H₂O | |
| 3 | 2Mg₃(OH)₅Cl•4H₂O | |
| 4 | Mg₁₀(OH)₁₈Cl₂•5H₂O | |
| 5 | 2Mg(OH)₂•MgCl₂•2H₂O | Phase 1 dihydrate; ~230° C. |
| 6 | 3Mg(OH)₂•MgCl₂•5H₂O | Phase 2 pentahydrate; ~110° C. |
| 7 | 3Mg(OH)₂•MgCl₂•4H₂O | Phase 2 tetrahydrate; ~140° C. |
| 8 | 5Mg(OH)₂•MgCl₂•4H₂O | Phase 3 tetrahydrate; ~120° C. |
| 9 | 5Mg(OH)₂•MgCl₂•3H₂O | Phasc 3 trihydrate; ~150° C. |
| 10 | 9Mg(OH)₂•MgCl₂•2H₂O | Phase 4 dihydrate; ~190° C. |

While existing technologies for producing alkalinity units depend on a process utilizing direct conversion of magnesium chloride to magnesium hydroxide or oxide, we discovered that under certain conditions, alkalinity units may be efficiently produced by processes that are designed to use only the first step, or equation 1 of the thermohydrolysis reaction, thus being able to utilize a wider range of input compositions and requiring much lower amounts of energy. In other embodiments, a multi-step process may be used that forms magnesium oxide and anhydrous magnesium chloride especially suitable for the electrowinning of magnesium magnesium metal. Thus, the present technology can be thought of as a very forgiving process for efficiently obtaining alkalinity units for deacidification and enhancing the carbon sequestration capacity of seas and oceans. In a sense, the present technology provides efficient processes for the production of hydrogen halide depleted alkali earth metal compositions, here termed hydrogen halide depleted compositions. These compositions are the source of the alkalinity units for the mitigation of sea and ocean acidification and the promotion of carbon sequestration.

As used herein, the expression “hydrogen halide depleted composition” refers to compositions obtained by processes that, starting from aqueous solutions, or solid hydrates of alkali earth metals, result in the evolution of hydrogen halide and the formation of hydroxide anions associated with the alkali earth metal. This term may be modified by specifying the particular alkali earth metal or hydrogen halide, but the general meaning remains the same. So, for example, we may refer to a hydrogen chloride depleted composition, which would result from subjecting an alkali earth chloride salt to thermohydrolysis, or we could refer to a hydrogen halide depleted calcium composition, which would result from subjecting a calcium halide salt to thermohydrolysis.

It is to be noted that hydrogen halide depleted composition encompasses not only compositions that result from Equations 1 and 2, but also to compositions that have subsequently underwent the reactions shown in Equations 3, or 4. It is to be noted that during the processes of the present technology, reactions 2 and 4 may take place concomitantly with reaction 1. Reaction 5 is caused to occur when the alkalinity unit or units are introduced into a body of water.

In some embodiments, these hydrogen chloride depleted compositions are mixed with aqueous solutions, here termed “sink brines”, and directed into seas and oceans, thus adding alkalinity units to those bodies of water, or are used to mitigate the environmentally detrimental properties of industrial waste streams. In other embodiments, these hydrogen chloride depleted compositions are directly directed into seas and oceans or to mitigate the environmentally detrimental properties of industrial waste streams. In still other embodiments, the processes described herein provide high purity magnesium chloride containing solutions or solids suitable for magnesium metal production or other industrial uses.

Thus, the present technology provides for the environmentally friendly production of alkalinity units suitable for introduction into sea and ocean waters or mitigate the environmentally detrimental properties of industrial waste streams.

In one embodiment, the present technology provides for systems, compositions, and methods for production of alkalinity units comprising sink brines enriched in alkali earth metal hydroxychlorides.

In other embodiments, the present technology provides for systems, compositions, and methods for reacting carbon dioxide with metal hydroxychloride enriched sink brines. In still other embodiments, the present technology provides for systems, compositions, and methods for increasing the alkalinity of seawater by introducing an alkali earth metal hydroxychloride, oxide, or hydroxide enriched sink brine into a sea or ocean. In other embodiments, the alkalinity units may comprise hydrogen chloride depleted compositions that can be deposited directly into seas and oceans without the intermediate step of mixing with a sink brine.

In one embodiment, the present technology provides for a process comprising: a) subjecting a source brine to a first thermal process, yielding a solid or slurry composition comprising an alkali earth metal chloride salt hydrate; b) subjecting the solid or slurry composition comprising the alkali earth metal chloride salt hydrate to a second thermal process yielding a composition comprising an alkali earth metal hydroxychloride salt and hydrogen chloride; c) separating the hydrogen chloride from the composition comprising an alkali earth metal hydroxychloride salt; and d) optionally, introducing the composition comprising an alkali earth metal hydroxychloride salt into a sea or ocean, thereby increasing the total alkalinity of the sea or ocean.

In another embodiment, the present technology provides for a process comprising: a) subjecting a source brine to a first a thermal process, yielding a solid or slurry composition comprising an alkali earth metal chloride salt hydrate; b) subjecting the solid or slurry composition comprising the alkali earth metal salt hydrate to a second thermal process yielding a composition comprising an alkali earth metal hydroxychloride salt and hydrogen chloride; c) separating the composition comprising an alkali earth metal hydroxychloride salt from the hydrogen chloride; d) contacting the composition comprising an alkali earth metal hydroxychloride salt with a sink brine to obtain an alkali earth metal hydroxide suspension in an alkali earth metal chloride salt solution; e) separating the suspension to obtain the metal hydroxide and the metal chloride solution; f) optionally, introducing the metal hydroxide into a sea or ocean, thereby increasing the total alkalinity of the sea or ocean; and g) optionally recovering the metal chloride salt from the metal chloride salt solution.

In still another embodiment, the present technology provides for a process comprising: a) contacting a source brine with calcium chloride to obtain a calcium sulfate suspension; b) removing the calcium sulfate to obtain a composition comprising the alkali earth metal chloride salt solution; c) subjecting the composition comprising the alkali earth metal chloride solution to a first thermal process, yielding a solid or slurry composition comprising a the metal chloride salt, d) subjecting the solid or slurry composition comprising the metal chloride salt to a second thermal process yielding a composition comprising an alkali earth metal hydroxychloride salt and hydrogen chloride; e) separating the hydrogen chloride from the composition comprising an alkali earth metal hydroxychloride salt; and f) optionally, introducing the metal hydroxychloride into a sea or ocean, thereby increasing the total alkalinity of the sea or ocean.

In one embodiment, the present technology provides for a process for increasing the alkalinity of a sea or ocean comprising: a) subjecting a source brine to an evaporative process, yielding a magnesium chloride hydrate; b) subjecting the magnesium salt hydrate to a thermal process yielding magnesium hydroxychloride and hydrogen chloride; c) separating the magnesium hydroxychloride from the hydrogen chloride; and d) introducing the magnesium hydroxychloride into a sea or ocean, thereby increasing the total alkalinity of the sea or ocean.

In another embodiment, the present technology provides for a process for increasing the alkalinity of a sea or ocean comprising: a) subjecting a source brine to an evaporative process, yielding a magnesium chloride hydrate; b) subjecting the magnesium salt hydrate to a thermal process yielding magnesium hydroxychloride and hydrogen chloride; c) separating the magnesium hydroxychloride from the hydrogen chloride; d) contacting the magnesium hydroxychloride with a sink brine to obtain a magnesium hydroxide suspension; e) separating the suspension to obtain the magnesium hydroxide and a magnesium chloride solution; f) introducing the magnesium hydroxide into a sea or ocean, thereby increasing the total alkalinity of the sea or ocean; and g) optionally recovering the magnesium chloride from the magnesium chloride solution.

In still another embodiment, the present technology provides for a process for increasing the alkalinity of a sea or ocean comprising: a) contacting a source brine with calcium chloride to obtain a calcium sulfate suspension; b) removing the calcium sulfate to obtain a magnesium chloride solution; c) subjecting the magnesium chloride solution to an evaporative process, yielding a concentrated magnesium chloride solution; d) subjecting the magnesium chloride solution to a thermal process yielding a solid composition comprising magnesium chloride, magnesium hydroxychloride and magnesium oxide, and, hydrogen chloride; e) separating the solid composition comprising magnesium chloride, magnesium hydroxychloride and magnesium oxide from the hydrogen chloride; f) subjecting the solid mixture of the magnesium chloride, the magnesium hydroxychloride and the magnesium oxide to a solvent separation step to obtain the magnesium salt and a mixture of the magnesium salt hydroxychloride and magnesium oxide; g) introducing the magnesium hydroxychloride and magnesium oxide mixture into a sea or ocean, thereby increasing the total alkalinity of the sea or ocean; and h) converting the magnesium chloride to elemental magnesium.

In another embodiment, the first or second thermal process may be an evaporative process. In still another embodiment, the hydrogen chloride is hydrogen chloride gas or a concentrated hydrochloric acid solution. In one embodiment, the metal chloride salt is magnesium chloride. In one embodiment, the metal hydroxychloride salt is magnesium hydroxychloride. In one embodiment, the metal hydroxide is magnesium hydroxide. In one embodiment, the metal oxide is magnesium oxide.

### BRIEF DESCRIPTION OF THE FIGURES

FIG. 1 illustrates a process of the present technology where a magnesium chloride containing source brine is converted by the reaction illustrated by equation 1 into alkalinity units comprising magnesium hydroxychloride.

FIG. 2 illustrates a process of the present technology where a magnesium chloride containing source brine is converted by the reaction illustrated by equation 1 into magnesium hydroxychloride, and further converted by the reaction illustrated by reaction 3 into alkalinity units comprising magnesium hydroxide and a solution of magnesium chloride.

FIG. 3 illustrates a process of the present technology where a purification step 310 is performed prior to the process illustrated in FIG. 1.

FIG. 4 illustrates a process of the present technology where alkalinity units are produced in conjunction with the production of anhydrous magnesium chloride suitable for the electrolytic production of magnesium metal.

FIG. 5 illustrates a process of the present technology where a solid or slurry composition comprising magnesium oxide and magnesium hydroxychloride is recovered from a settling tank and deposited to a sea or ocean.

FIG. 6 illustrates a graph of the time course of the removal of carbon dioxide from an atmosphere by a composition synthesized by heating magnesium chloride hexahydrate at 450 deg. C. for 4 hours.

FIG. 7 illustrates a graph of the time course of the change in pH of the seawater enriched by a composition synthesized by heating magnesium chloride hexahydrate at 450 deg. C. for 4 hours during the removal of carbon dioxide from an atmosphere.

FIG. 8 illustrates a graph of the time course of the change in salinity of the seawater enriched by a composition synthesized by heating magnesium chloride hexahydrate at 450 deg. C. for 4 hours during the removal of carbon dioxide from a carbon dioxide enriched atmosphere.

FIG. 9 illustrates a graph of the time course of the ambient temperature of the seawater enriched by a composition synthesized by heating magnesium chloride hexahydrate at 450 deg. C. for 4 hours during the removal of carbon dioxide from an atmosphere.

FIG. 10 is a picture of the haze formed by precipitation of minerals during the removal of carbon dioxide from an atmosphere that has been enriched in carbon dioxide.

FIG. 11 is a plot of the data shown in Table 6 relating the temperature of the dehydration to the ratio of formation of magnesium oxide to the formation of anhydrous magnesium chloride.

### DETAILED DESCRIPTION

Unless defined otherwise, all technical and scientific terms used herein have the same meaning as is commonly understood by one of ordinary skill in the art to which the present technology belong. All patents, patent applications, published applications and publications, websites and other published materials referred to throughout the entire disclosure herein, unless noted otherwise, are incorporated by reference in their entirety. In the event that there are a plurality of definitions for terms herein, those in this section prevail. Where reference is made to a URL or other such identifier or address, it is understood that such identifiers can change and particular information on the internet can come and go, but equivalent information can be found by searching the internet. Reference thereto evidences the availability and public dissemination of such information.

While the present technology has been described in connection with specific embodiments thereof, it will be understood that it is capable of further modifications and this application is intended to cover any variations, uses, or adaptations of the present technology, including such departures from the present disclosure as come within known or customary practice within the art to which the present technology pertains and as may be applied to the essential features hereinbefore set forth, and as follows in the scope of the appended claims.

As used herein, the singular forms “a,” “an” and “the” include plural referents unless the context clearly dictates otherwise.

As used herein, ranges and amounts can be expressed as “about” a particular value or range. “About” also includes the exact amount. Hence “about 5 percent” means “about 5 percent” and also “5 percent.” As used herein, the term “about” means within typical experimental error for a measurement typically used for purpose intended, or, if referred to in the context of a process parameter, the term about should be construed in the context of the sensitivity of such process to the particular parameter. When a list of parameters or ranges is preceded by the term “about”, it is intended that the term “about” applies to each of the members of the list.

As used herein, “optional” or “optionally” means that the subsequently described event or circumstance does or does not occur, and that the description includes instances where the event or circumstance occurs and instances where it does not. For example, an optional component in a system means that the component may be present or may not be present in the system.

As used herein, “weight percent” or “wt %” refers to the concentration of a substance as the weight of that substance divided by the total weight of the composition and multiplied by 100.

As used herein, unless specifically noted, the term “or” means inclusive “or.” So the term (A or B) means A, B, as well as A and B.

It is appreciated that certain features of the present technology, which are, for clarity, described in the context of separate embodiments, may also be provided in combination in a single embodiment. Conversely, various features of the present technology, which are, for brevity, described in the context of a single embodiment, may also be provided separately or in any suitable sub-combination. All combinations of the embodiments pertaining to the present technology are specifically embraced by the present technology and are disclosed herein just as if each and every combination was individually and explicitly disclosed. In addition, all sub-combinations of the various embodiments and elements thereof are also specifically embraced by the present technology and are disclosed herein just as if each and every such sub-combination was individually and explicitly disclosed herein.

Where an optional step is recited in an embodiment, the intention is that the embodiment discloses both the process incorporating the optional step, as well as the process omitting the optional step.

As used herein, the expression “source brine” refers to any aqueous solution comprising an alkali earth metal compound. Typically, the alkali earth metal compound may be an alkali earth metal salt, alkali earth metal oxide, alkali earth metal carbonate, alkali earth metal bicarbonate, alkali earth metal hydroxide, or alkali earth metal hydroxyhalide. Typical source brines include, but are not limited to, ocean water, sea water, brines such as derived from bodies of water such as The Great Salt Lake, and bitterns such as, but not limited to sea salt or potash bitterns.

In some preferred embodiments, the alkali earth metal is magnesium, and the source brines comprise magnesium chloride. In other preferred embodiments, the alkali earth metal is calcium, and the source brines comprise calcium chloride.

As used herein, the term “sink brine” refers to freshwater, seawater or other aqueous solution which is environmentally suitable for discharge into a sea or ocean or for use as a scrubbing medium for industrial waste streams such as flue gases.

As used herein, the expression “sea or ocean” means any natural or man-made body of water with an average salinity of greater than 6 g/kg of sodium chloride. In one embodiment, source or sink brines may be seawater, geothermal brines, effluents from desalination systems, solar ponds, potash brines, or bitterns. In another embodiment, the source or sink brines may be synthetic brines. Typically, synthetic source brines may be effluents from industrial chemical processes such as desalination plants or any other process that produces an aqueous stream comprising dissolved or suspended magnesium compounds. Typically, a sink brine is seawater.

As used herein, the expression “alkalinity unit” refers to a composition comprising a hydrogen chloride depleted composition comprising an alkali earth metal hydroxyhalide, an alkali earth metal hydroxide, an alkali metal oxide, an alkali metal bicarbonate, or an alkali earth metal carbonate, each of which, alone, or in combination, increases the pH of an aqueous solution into which it is introduced. A typical alkalinity unit will be the mass of the hydrogen halide or hydrogen chloride depleted composition that causes the body of water into which it is deposited to absorb an additional amount of carbon dioxide over a period of about 1 year than would have been absorbed if no alkalinity units had been deposited therein and therefore entitles the party that deposits the alkalinity units into the body of water to carbon removal (offset) credits, in this case, the class of credits are sometimes called “marine CDR” or “mCDR”.

While the process of the present technology provides for earning of carbon removal credits, the generation of anhydrous magnesium chloride by some of the processes may also entitle the operator for carbon mitigation credits that reward the avoidance of carbon dioxide production in industrial processes, here, the production of magnesium metal from the more efficiently produced anhydrous magnesium chloride. This amount would correspond to the denomination of the carbon credit which typically be one ton of carbon dioxide removed from the atmosphere, though they are typically traded in lots of 100 to 1000 tons of carbon dioxide captured or mitigated. However, the denomination is used here for convenience and may be any amount that qualifies the operator for a carbon credit that is issuable upon completion of a process described herein. Carbon credits are traded on several financial exchanges, such as, but not limited to Carbon Trade Exchange, (CTX, https://ctxglobal.com/), Aircarbon Exchange (ACX, https://acx.net/), Xpansiv and Toucan (https://toucan.earth/). Credits may also trade on financial exchanges such as the Chicago Mercantile Exchange. The carbon credits traded on the CTX include: Voluntary Emmission reduction (VER), Certified Emission Reduction (CER), Verified Carbon Units (VCU), and European Allowance (EUAA). The carbon credits trading on the ACX include: CORSIA eligible Token (CET), Renewable Energy Token (RET), Global Nature Token (GNT), Nature Based Token Accompanied by Additional Certifications for Co-Benefits Achieved (GNT+), Sustainable development token (SDT), and Household Offset Token (HOT). The carbon credits trading on the Xpansive exchange include Global Emissions Offset (CBL GEO), Nature-Based Global Emissions offset (CBL-N-GEO), and the Core Global Emissions OFFSET (CBL C-GEO). The carbon credits trading on the Toucan exchange is the TCO2 and BCT.

Thus, in some embodiments, the present technology provides for compositions, methods, and systems for earning carbon credits such as, but not limited to, VER, CER, VCU, EUAA, CET, RET, GNT, GNT+, SDT, HOT, CBL GEO, CBL N-GEO, CBL C-GEO, BCT and TCO2.

The carbon credits may be claimed or sold through an exchange, or directly from a counterparty wishing to offset emission or decrease the existing levels of carbon dioxide in the atmosphere or ocean. The counterparties may be, but are not limited to private industrial operators, corporations, public benefit corporations, foundations, Distributed Autonomous Organizations (DAOs), Block Chains, philanthropists and philanthropical organizations, non-governmental organizations (NGOs), local, state, provincial, national and international bodies.

It is noted that the removal of carbon in the form of carbon dioxide, or soluble carbonates from a body of water shifts the equilibrium described in Equation 5 such that, over time, will result in removal of carbon dioxide from the atmosphere and in some instances, increase the pH of the body of water.

Preferred alkalinity units are compositions comprising magnesium or calcium hydroxychlorides, magnesium or calcium hydroxides, magnesium or calcium oxides, magnesium or calcium bicarbonates, or magnesium or calcium carbonates.

The present technology provides for the environmentally friendly production of alkalinity units suitable for introduction into sea or ocean waters, and optionally providing feedstocks for other industrial processes.

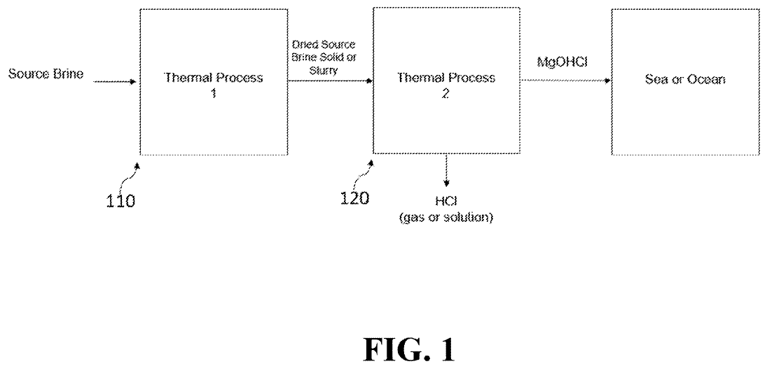

FIG. 1 illustrates a process according to one embodiment of the present technology where a magnesium chloride containing source brine is converted by the reaction illustrated by equation 1 into alkalinity units comprising magnesium hydroxychloride. As shown in FIG. 1, a source brine is converted to a solid or slurry by a first thermal process 110, then the solid or slurry is subjected to a second thermal process 120, resulting in the liberation of hydrogen chloride and a magnesium hydroxychloride enriched residue which is deposited into a sea or ocean. In some instances, the first thermal process and the second thermal process may be combined into a single unit operation or be performed sequentially in a single piece of equipment. In some embodiments, the first thermal process may be an evaporative process. Typically, an evaporative process may comprise simply leaving a source brine in a solar pond until the required degree of evaporation has taken place, or, it may comprise a process of subjecting the source brine to a piece of evaporative equipment such as a film evaporator, rotary evaporator or other equipment suitable for evaporating solvents from solutions, slurries, or wet solids such as, but not limited to, rotary dryer, kiln, fluidized bed dryer, drum dryer, spray dryer, tray dryer, cabinet dryer, vacuum shelf dryer, microwave dryer, belt dryers, flash tube dryers, tube bundle dryers, or ultrasonic dryer. In some cases, two or more types of drying methods may be employed in series. Other types of evaporators suitable for handling slurries or solutions include, but are not limited to boilers, crystallizers, wiped film evaporators, falling film evaporators, draft tube crystallizers, calandria-type crystallizers, forced circulation crystallizers, natural circulation crystallizers, single stage flash with intermediate gas/slurry separation, baffled crystallizers, surface cooled crystallizers, fluidized suspension crystallizers, mixed suspension mixed product removal crystallizers, and flash drums. This process is energy efficient because the dried source brine solid or slurry can comprise relatively large amounts of higher hydrates of magnesium chloride, thus not requiring as much energy as would the production of compositions comprising relatively low amounts of magnesium hexahydrate for the subsequent thermohydrolysis step. The subsequent thermohydrolysis step is also energy efficient since complete thermohydrolysis to the hydroxide or oxide is not required to generate the alkalinity unit. Although the buffering capacity of magnesium hydroxychloride is lower on a molar basis than that of magnesium hydroxide or magnesium oxide, the most costly input, the energy required to drive the reaction, is considerably less, thus making the overall process more efficient.

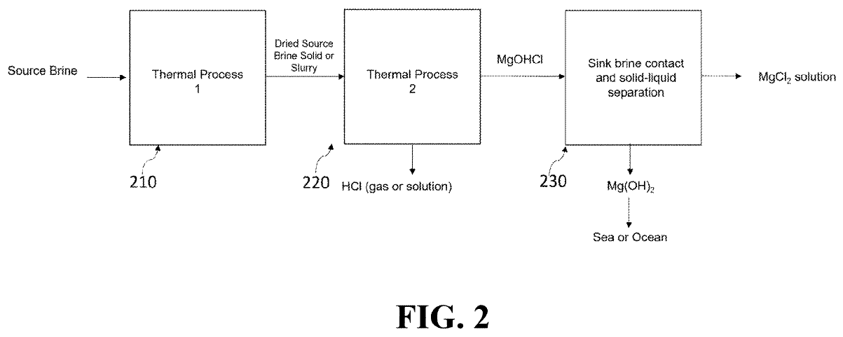

FIG. 2 illustrates the process of FIG. 1 where a second step of reacting the magnesium hydroxychloride according to equation 3 is performed in an energy efficient manner by allowing the magnesium hydroxychloride to remain in contact with the sink brine in the process 230 so that the precipitation of magnesium hydroxide drives the reaction towards completion without the need for a thermal source to drive the reaction. The process 230 can be accomplished by means generally known in the art such as stirred reactors, settling tanks, centrifugal filtration or other equipment suitable for conducting the reaction and subsequent separation of the products. The resulting magnesium chloride solution may be recycled as the source brine or used in other industrial processes such as the production of electrolytic magnesium metal. The evolved hydrogen chloride may likewise be used in other industrial processes.

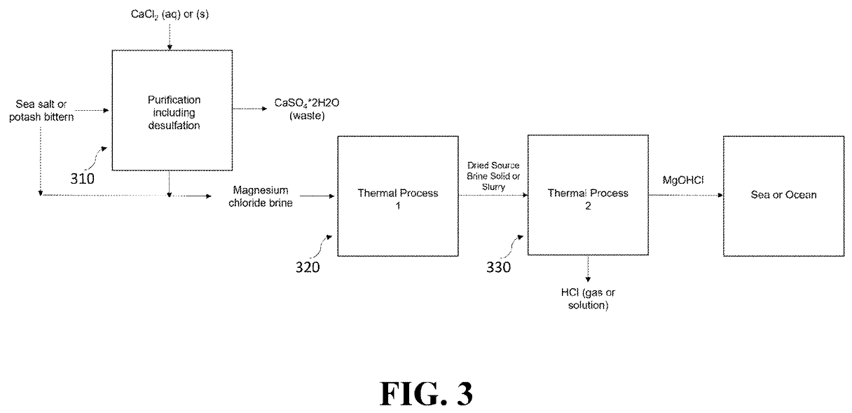

FIG. 3 illustrates a process of the present technology where a purification step 310 precedes the process illustrated in FIG. 1. Here, a calcium chloride solution is added to the source brine to precipitate sulfate. This is useful in the case of the use of certain bitterns that have high concentrations of sulfate that could cause undesired reactions in steps 320 or 330.

In some embodiments, the hydrogen chloride produced by the thermohydrolysis processes of the present technology may be used to recycle the calcium sulfate produced in the purification step into calcium chloride, thus mitigating the need for large amounts of external calcium chloride input.

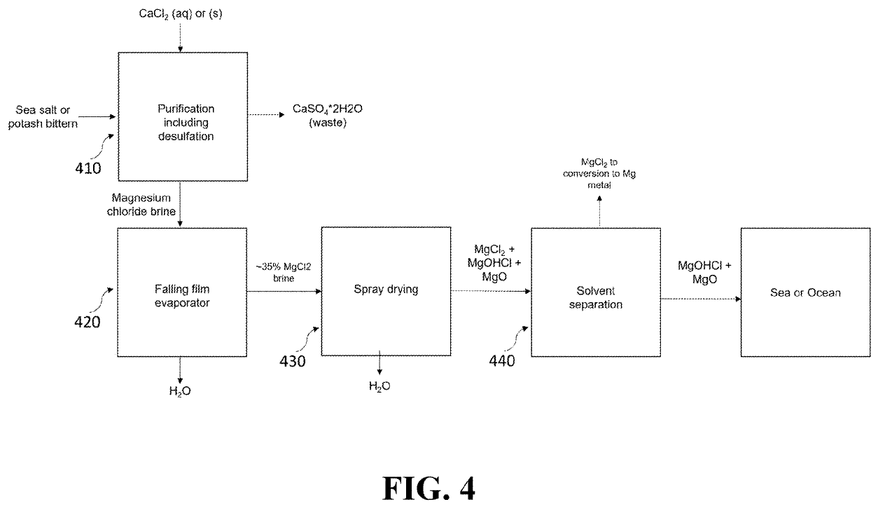

FIG. 4 illustrates a process of the present technology where a falling film evaporator 420 is used to concentrate a desulfated source brine before it is subjected a spray drying process 430. While this example shows the concentrated magnesium chloride brine to have a concentration of 35% magnesium chloride, the concentration of magnesium chloride may range from about 10% to 50%. After concentration, the concentrated magnesium chloride brine undergoes partial thermohydrolysis according to equations 1 and 4 to yield a composition comprising magnesium chloride, magnesium hydroxychloride and magnesium oxide. This composition is then subjected to a solvent separation step 440 wherein anhydrous magnesium chloride is produced in conjunction with the alkalinity units comprising magnesium hydroxychloride and magnesium oxide.

In one embodiment, the solvent used in the solvent separation step is an alcohol. In another embodiment, the solvent used in the solvent separation step is methanol. In another embodiment, the solvent used in the solvent separation step is ethanol. In one embodiment, the solvent used in the solvent separation step comprises an alcohol. In another embodiment, the solvent used in the solvent separation step comprises methanol. In another embodiment, the solvent used in the solvent separation step comprises ethanol.

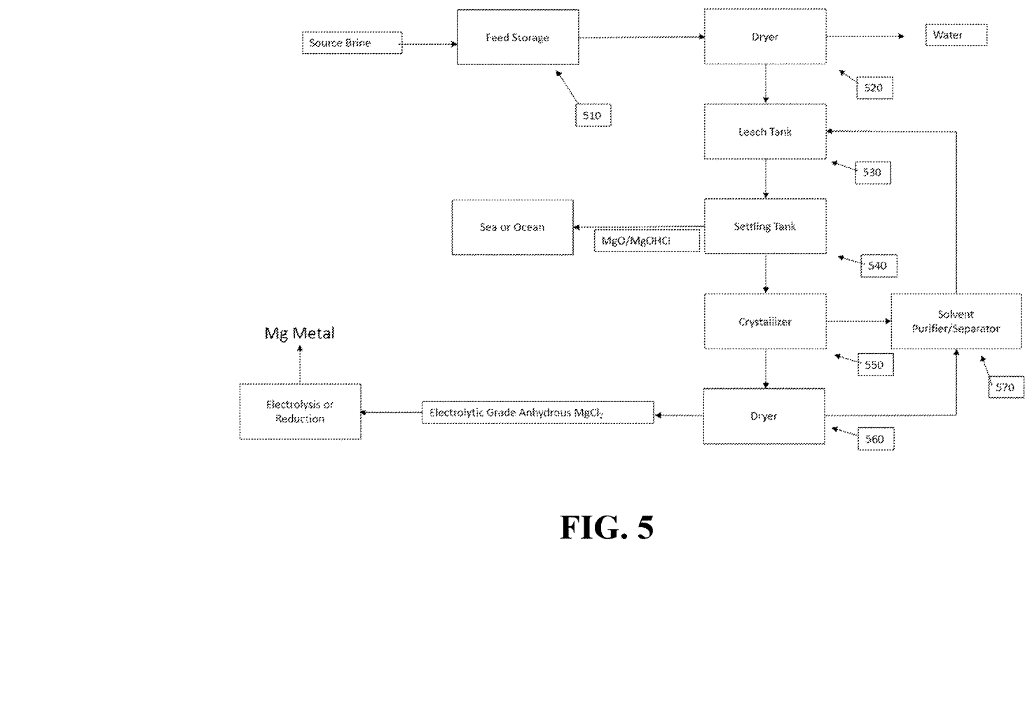

FIG. 5 illustrates a process of the present technology where a source brine is used directly in the solvent extraction process to generate anhydrous magnesium chloride in conjunction with alkalinity units comprising magnesium hydroxychloride and magnesium oxide. In this exemplary embodiment, the source brine comprising crude magnesium chloride is introduced into a feed supply 510, where crude magnesium chloride is stored before being fed into the dryer 120. The brine in the feed supply 510 can be stored in tanks, ponds, underground tanks, underground salt caverns, or channels. The type of dryer 520 can be a rotary dryer, kiln, fluidized bed dryer, drum dryer, spray dryer, tray dryer, cabinet dryer, vacuum shelf dryer, microwave dryer, belt dryers, flash tube dryers, tube bundle dryers, or ultrasonic dryer, or any other crystallizer, or drying equipment described herein. In some cases, two or more types of drying methods may be employed in series. In certain applications, the feed supply 510 may not comprise storage, but be an inlet to the dryer 520. In this case, the crude MgCl₂ may be directly introduced into the dryer 520. Once the crude magnesium chloride has been dried, typically to about two waters of hydration, the crude, dry magnesium chloride is charged into the leach tank 530, where it is treated with a solvent system comprising one, or a combination of solvents and agitated for a period of time to allow the magnesium chloride to dissolve. The time interval required may be based on the nature of the crude magnesium chloride, such as particle size, impurity profile and degree of hydration, or temperature, or may be determined by periodically assaying the concentration of magnesium chloride dissolved in the solvent. The leach tank may be agitated with various agitators, tumblers, gas impringers, or baffles. Multiple leach tanks can be implemented to run in series on in a counter current fashion. The residence time of the MgCl₂ in the tanks typically will range from about 5 minutes to about 2 hours, 2 hours to 5 hours, 5 hours to 12 hours, 12 hours to 24 hours, or 24 hours to 7 days. After the requisite time interval, the solvent, along with suspended impurities is transferred into a settling tank 540, where the solid impurities are removed. Alternatively, the solids may be removed by filtration, flocculation, centrifugation, or any other such methods known in the art. The settled solids are then transferred to an acidifier 580, and treated with HCl gas to convert any magnesium oxide and magnesium hydroxychloride to crude magnesium chloride which is transferred into feed storage. The hydrogen chloride gas may be captured from the thermohydrolysis step. Once the solid impurities have been removed, the magnesium chloride solution is transferred into a crystallizer 550, where the purified magnesium chloride is crystallized out. The crystallization process may be performed by evaporation, temperature manipulation, addition of a counter solvent, or other way known in the art. Once the crystallization process has been completed, the solid magnesium chloride may be separated from the solvent by settling, filtration, centrifugation, or other dewatering methods known in the art. Depending on the solvent system used and the crystallization method, the crystallized magnesium chloride may retain some waters of hydration, crystallize as a solvate, or as anhydrous magnesium chloride. The crystallized magnesium chloride is then transferred into a dryer 560, where the residual solvent or solvent of hydration is removed. The solvent from the crystallizer and the dryer 560 is recycled by the solvent purifier/separator 170, and the recycled solvent is sent back to the leach tank for the next round of purification. The purification of the solvent may be accomplished by distillation or crystallization in the case of high melting point solvents. Any residual water, if the solvent system employed is anhydrous, if not separable through simple fractional distillation, may be removed by treatment with a drying agent, such as, but not limited to molecular sieves, CaCl₂), MgSO₄, CaSO₄, H₂SO₄, alumina, CaO, or azeotropic desiccation.

In one embodiment, the present technology provides for a process comprising: subjecting a source brine to an evaporative process, yielding an alkali earth metal halide salt hydrate; subjecting the alkali earth metal salt hydrate to a thermal process yielding an alkali earth metal hydroxyhalide salt and a hydrogen halide; separating the hydrogen halide from the composition comprising an alkali earth metal hydroxyhalide salt; and optionally, introducing the metal hydroxyhalide salt into a sea or ocean, thereby increasing the total alkalinity of the sea or ocean.

In another embodiment, the present technology provides for a process comprising: subjecting a source brine to an evaporative process, yielding an alkali earth metal halide salt hydrate; subjecting the alkali earth metal salt hydrate to a thermal process yielding an alkali earth metal hydroxyhalide salt and a hydrogen halide; separating the hydrogen halide from the composition comprising an alkali earth metal hydroxyhalide salt; contacting the alkali earth metal hydroxyhalide salt with a sink brine to obtain an alkali earth metal hydroxide suspension; separating the suspension to obtain the alkali earth metal hydroxide and an alkali metal halide solution; introducing the alkali earth metal hydroxide into a sea or ocean, thereby increasing the total alkalinity of the sea or ocean; and optionally recovering the alkali earth metal halide salt from the alkali earth metal halide solution, and optionally, introducing the recovered alkali earth metal halide salt into a sea or ocean, thus total alkalinity of the sea or ocean.

In some embodiments, the alkali earth metal hydroxide suspension may be directly used as a carbon sequestration composition to remove carbon dioxide directly from industrial waste streams such as flue gases.

In one embodiment, the present technology provides for a process comprising: contacting a source brine with calcium chloride to obtain a calcium sulfate suspension; removing the calcium sulfate to obtain an alkali earth metal halide salt solution; subjecting the alkali earth metal halide solution to an evaporative process, yielding an alkali earth metal halide salt hydrate, subjecting the alkali earth metal salt hydrate to a thermal process yielding an alkali earth metal hydroxyhalide salt and a hydrogen halide; separating the hydrogen halide from the composition comprising an alkali earth metal hydroxyhalide salt; and optionally, introducing the metal hydroxyhalide salt into a sea or ocean, thereby increasing the total alkalinity of the sea or ocean.

In still another embodiment, the present technology provides for a process comprising: contacting a source brine with calcium chloride to obtain a calcium sulfate suspension; removing the calcium sulfate to obtain an alkali earth metal halide salt solution; subjecting the alkali earth metal halide solution to an evaporative process, yielding a concentrated alkali earth metal halide salt solution; subjecting the alkali earth metal halide salt hydrate to a thermal process yielding a solid composition comprising the alkali earth metal halide salt, an alkali earth metal hydroxyhalide salt and an alkali earth metal oxide and, a hydrogen halide; separating the hydrogen halide from the solid composition comprising the alkali earth metal halide salt, an alkali earth metal hydroxyhalide salt and an alkali earth metal oxide; subjecting the solid mixture of the alkali earth metal halide salt, the alkali earth metal hydroxyhalide salt and the alkali earth metal oxide to a solvent separation step to obtain the alkali earth metal salt and a mixture of the alkali earth metal salt hydroxyhalide and alkali earth metal oxide; and optionally, introducing the alkali earth metal hydroxyhalide and alkali earth metal oxide mixture into a sea or ocean, thereby increasing the total alkalinity of the sea or ocean; and optionally converting the alkali earth metal halide salt to an elemental alkali earth metal.

In one embodiment, the present technology provides for a process comprising: subjecting a source brine to an evaporative process, yielding an alkali earth metal chloride salt hydrate; subjecting the alkali earth metal salt hydrate to a thermal process yielding an alkali earth metal hydroxychloride salt and hydrogen chloride; separating the hydrogen chloride from the composition comprising an alkali earth metal hydroxychloride salt; optionally, introducing the alkali earth metal hydroxychloride salt into a sea or ocean, thereby increasing the total alkalinity of the sea or ocean.

In another embodiment, the present technology provides for a process comprising: subjecting a source brine to an evaporative process, yielding an alkali earth metal chloride salt hydrate; subjecting the alkali earth metal chloride salt hydrate to a thermal process yielding an alkali earth metal hydroxychloride salt and hydrogen chloride; separating the hydrogen chloride from the composition comprising an alkali earth metal hydroxychloride salt; contacting the alkali earth metal hydroxychloride salt with a sink brine to obtain an alkali earth metal hydroxide suspension; separating the suspension to obtain the alkali earth metal hydroxide and a alkali earth metal chloride solution; and optionally, introducing the alkali earth metal hydroxide into a sea or ocean, thereby increasing the total alkalinity of the sea or ocean; and optionally recovering the alkali earth metal chloride salt from the alkali earth metal chloride solution.

In some embodiments, the alkali earth metal hydroxide suspension may be directly used as a carbon sequestration composition to remove carbon dioxide directly from industrial waste streams such as flue gases.

In still another embodiment, the present technology provides for a process comprising: contacting a source brine with calcium chloride to obtain a calcium sulfate suspension; removing the calcium sulfate to obtain an alkali earth metal chloride salt solution; subjecting the alkali earth metal chloride solution to an evaporative process, yielding a concentrated alkali earth metal chloride salt solution; subjecting the alkali earth metal chloride salt hydrate to a thermal process yielding a solid composition comprising an alkali earth metal chloride salt, an alkali earth metal hydroxychloride salt and an alkali earth metal oxide, and, hydrogen chloride; separating the hydrogen chloride from the solid composition comprising the alkali earth metal chloride salt, an alkali earth metal hydroxychloride salt and an alkali earth metal oxide; subjecting the solid composition comprising an alkali earth metal chloride salt, an alkali earth metal hydroxychloride salt and an alkali earth metal oxide to a solvent separation step to obtain the alkali earth metal chloride salt and a mixture of an alkali earth metal hydroxychloride salt and an alkali earth metal oxide; introducing the alkali earth metal hydroxychloride salt and the alkali earth metal oxide mixture into a sea or ocean, thereby increasing the total alkalinity of the sea or ocean; and optionally converting the alkali earth metal salt to an elemental alkali earth metal.

In one embodiment, the present technology provides for a process comprising: subjecting a source brine to a first an evaporative process, yielding a magnesium chloride hydrate; subjecting the magnesium salt hydrate to a thermal process yielding magnesium hydroxychloride and hydrogen chloride; separating the hydrogen chloride from the magnesium hydroxychloride; and introducing the magnesium hydroxychloride into a sea or ocean, thereby increasing the total alkalinity of the sea or ocean.

In another embodiment, the present technology provides for a process comprising: subjecting a source brine to an evaporative process, yielding a magnesium chloride hydrate; subjecting the magnesium salt hydrate to a thermal process yielding magnesium hydroxychloride and hydrogen chloride; separating the hydrogen halide from the magnesium hydroxychloride; contacting the magnesium hydroxychloride with a sink brine to obtain a magnesium hydroxide suspension; separating the suspension to obtain the magnesium hydroxide and magnesium chloride solution; and optionally, introducing the magnesium hydroxide into a sea or ocean, thereby increasing the total alkalinity of the sea or ocean; and optionally, recovering the magnesium chloride from the magnesium chloride solution.

In some embodiments, the magnesium hydroxide suspension may be directly used as a carbon sequestration composition to remove carbon dioxide directly from industrial waste streams such as flue gases.

In still another embodiment, the present technology provides for a process comprising: contacting a source brine with calcium chloride to obtain a calcium sulfate suspension; removing the calcium sulfate to obtain a magnesium chloride solution; subjecting the magnesium chloride solution to an evaporative process, yielding a concentrated magnesium chloride solution; subjecting the magnesium chloride hydrate to a thermal process yielding a solid composition comprising magnesium chloride, a magnesium hydroxychloride and magnesium oxide, and, hydrogen chloride; subjecting the solid composition comprising magnesium chloride, magnesium hydroxychloride and magnesium oxide to a solvent separation step to obtain the magnesium chloride and a mixture of the magnesium salt hydroxychloride and magnesium oxide; and optionally, introducing the magnesium hydroxychloride and magnesium oxide mixture into a sea or ocean, thereby increasing the total alkalinity of the sea or ocean; and optionally converting the magnesium chloride to elemental magnesium metal.

In one embodiment, the alkali earth metal chloride is magnesium chloride. In one embodiment, the alkali earth metal hydroxychloride is magnesium hydroxychloride. In one embodiment, the alkali earth metal hydroxide is magnesium hydroxide. In one embodiment, the alkali earth metal oxide is magnesium oxide.

In one embodiment, the solvent used in the solvent separation step is an alcohol. In another embodiment, the solvent used in the solvent separation step is methanol. In another embodiment, the solvent used in the solvent separation step is ethanol. In one embodiment, the solvent used in the solvent separation step comprises an alcohol. In another embodiment, the solvent used in the solvent separation step comprises methanol. In another embodiment, the solvent used in the solvent separation step comprises ethanol.

One aspect of the present technology is that the hydrogen chloride generated in the thermal processes may be recovered in a readily usable form such as a gas, or as a concentrated solution of hydrochloric acid. In one embodiment, the hydrogen chloride is hydrogen chloride gas or a concentrated hydrochloric acid solution.

In one embodiment the hydrochloric acid solution has a concentration of about 5% to about 10%, about 10% to about 15%, about 15% to about 20%, about 20% to about 25%, about 25% to about 30%, about 30% to about 35%, and about 35% to about 40%.

The thermal processes referred herein may be conducted with the concomitant evaporation of water or a solvent, or, under conditions where no appreciable evaporation of water or solvent occurs. In certain embodiments, a thermal process is an evaporative process.

In some embodiments, the magnesium chloride hydrate subjected to a thermal process to yield magnesium hydroxychloride is in the form of the dihydrate. In some embodiments, the magnesium chloride hydrate subjected to a thermal process to yield magnesium hydroxychloride is comprised of more than about 45% of the dihydrate. In some embodiments, the magnesium chloride hydrate subjected to a thermal process to yield magnesium hydroxychloride is comprised of more than about 50% of the dihydrate. In some embodiments, the magnesium chloride hydrate subjected to a thermal process to yield magnesium hydroxychloride is comprised of more than about 55% of the dihydrate. In some embodiments, the magnesium chloride hydrate subjected to a thermal process to yield magnesium hydroxychloride is comprised of more than about 60% of the dihydrate. In some embodiments, the magnesium chloride hydrate subjected to a thermal process to yield magnesium hydroxychloride is comprised of more than about 65% of the dihydrate. In some embodiments, the magnesium chloride hydrate subjected to a thermal process to yield magnesium hydroxychloride is comprised of more than about 65% of the dihydrate. In some embodiments, the magnesium chloride hydrate subjected to a thermal process to yield magnesium hydroxychloride is comprised of more than about 70% of the dihydrate. In some embodiments, the magnesium chloride hydrate subjected to a thermal process to yield magnesium hydroxychloride is comprised of more than about 75% of the dihydrate. In some embodiments, the magnesium chloride hydrate subjected to a thermal process to yield magnesium hydroxychloride is comprised of more than about 80% of the dihydrate. In some embodiments, the magnesium chloride hydrate subjected to a thermal process to yield magnesium hydroxychloride is comprised of more than about 85% of the dihydrate. In some embodiments, the magnesium chloride hydrate subjected to a thermal process to yield magnesium hydroxychloride is comprised of more than about 90% of the dihydrate. In some embodiments, the magnesium chloride hydrate subjected to a thermal process to yield magnesium hydroxychloride is comprised of more than about 95% of the dihydrate.

In some embodiments, the magnesium chloride hydrate subjected to a thermal process to yield magnesium hydroxychloride is in the form of the hexahydrate. In some embodiments, the magnesium chloride hydrate subjected to a thermal process to yield magnesium hydroxychloride is comprised of less than about 45% of the tetrahydrate. In some embodiments, the magnesium chloride hydrate subjected to a thermal process to yield magnesium hydroxychloride is comprised of more than about 45% of the hexahydrate.

In a preferred embodiment, magnesium chloride dihydrate is subjected to a thermal process to yield magnesium hydroxychloride at a temperature between about 170 C° and about 450° C. In another preferred embodiment, magnesium chloride dihydrate is subjected to a thermal process to yield magnesium hydroxychloride at a temperature between about 170 C° and about 400° C. In another preferred embodiment, magnesium chloride dihydrate is subjected to a thermal process to yield magnesium hydroxychloride at a temperature between about 170 C° and about 350° C. In another preferred embodiment, magnesium chloride dihydrate is subjected to a thermal process to yield magnesium hydroxychloride at a temperature between about 170 C° and about 325° C. In another preferred embodiment, magnesium chloride dihydrate is subjected to a thermal process to yield magnesium hydroxychloride at a temperature between about 170 C° and about 300° C. In another preferred embodiment, magnesium chloride dihydrate is subjected to a thermal process to yield magnesium hydroxychloride at a temperature between about 170 C° and about 275° C. In another preferred embodiment, magnesium chloride dihydrate is subjected to a thermal process to yield magnesium hydroxychloride at a temperature between about 170 C° and about 250° C. In another preferred embodiment, magnesium chloride dihydrate is subjected to a thermal process to yield magnesium hydroxychloride at a temperature between about 170 C° and about 250° C. In another preferred embodiment, magnesium chloride dihydrate is subjected to a thermal process to yield magnesium hydroxychloride at a temperature between about 170 C° and about 225° C. In another preferred embodiment, magnesium chloride dihydrate is subjected to a thermal process to yield magnesium hydroxychloride at a temperature between about 170 C° and about 200° C. In another preferred embodiment, magnesium chloride dihydrate is subjected to a thermal process to yield magnesium hydroxychloride at a temperature between about 180 C° and about 350° C. In another preferred embodiment, magnesium chloride dihydrate is subjected to a thermal process to yield magnesium hydroxychloride at a temperature between about 200 C° and about 325° C. In another preferred embodiment, magnesium chloride dihydrate is subjected to a thermal process to yield magnesium hydroxychloride at a temperature between about 225 C° and about 300° C. In another preferred embodiment, magnesium chloride dihydrate is subjected to a thermal process to yield magnesium hydroxychloride at a temperature between about 250 C° and about 275° C. In another preferred embodiment, magnesium chloride dihydrate is subjected to a thermal process to yield magnesium hydroxychloride at a temperature between about 275 C° and about 350° C. In another preferred embodiment, magnesium chloride dihydrate is subjected to a thermal process to yield magnesium hydroxychloride at a temperature between about 200 C° and about 300° C. In another preferred embodiment, magnesium chloride dihydrate is subjected to a thermal process to yield magnesium hydroxychloride at a temperature between about 225 C° and about 250° C.

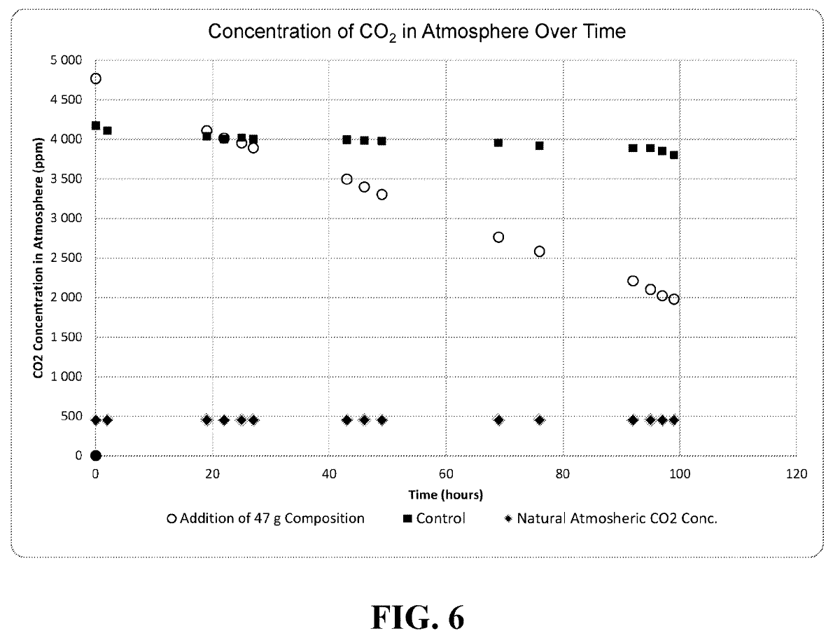

FIG. 6 shows the time course data of the concentration of CO₂ in a carbon dioxide enriched atmosphere (Open Circle: MgOHCl in seawater in controlled atmosphere, solid Square: control seawater in controlled atmosphere, Solid Diamond: the concentration of CO₂ in the atmosphere in nature) obtained in the following experiment demonstrating a process where a sample of ocean brine obtained from the San Francisco Bay is used to generate alkalinity units and decrease the carbon dioxide concentration of a carbon dioxide enriched atmosphere that is exposed to it. Synthesis: MgCl₂·6H2O was obtained from Molekula Chemical Co. Seawater was obtained from San Francisco Bay. MgOHCl was synthesized by heating 167 g of solid MgCl₂·6H₂O to 450° C. for four hours in a corked filter flask. This flask was insulated. The off-gas was bubbled through a Na₂CO₃ solution for neutralization of HCl vapors. No melting was noted. The sample hardened and was broken into ˜1 cm chunks. No further processing of the sample was performed. Analysis by a modified literature method (Method To Determine MgO and MgOHCl in Chloride Molten Salts, Noah Klammer, Chaiwat Engtrakul, Youyang Zhao, Yilin Wu, and Judith Vidal, Analytical Chemistry 2020 92 (5), 3598-3604, DOI: 10.1021/acs.analchem.9b04301) found that the MgOHCl content was 78%, showing the “MgOHCl” obtained was 22% anhydrous MgCl₂ equivalent and 78% MgOHCl. Model Ocean Environment: A model ocean environment was set up in a glovebox. A metal tray was plasti-dipped beforehand to limit corrosion during the experiment. The tray was filled with the ocean water and the CO₂ concentration in the atmosphere was increased ˜10 fold compared to a standard atmosphere (450 ppm) using a tank of compressed pure CO₂. The pH, temperature, and humidity were monitored. The salinity was not monitored for the control experiment but was measured for the active experiment involving MgOHCl addition to the seawater. These parameters were monitored 3-4 times per day for at least a week until a steady state was obtained. The experiment included adding 37 g of MgOHCl, synthesized as described above, to 2,900 g of seawater, the control did not include any MgOHCl in 2,800 g of seawater. A baseline leakage experiment, for 4 days showed no drop in CO₂ atmosphere suggesting leakage rates were extremely low. Control: The control experiment was performed for a total of 7 days. The starting atmospheric CO₂ concentration in the glovebox was around 4,200 ppm. This value was used as the starting concentration in order to speed up the rate at which measurable changes in CO₂ would occur and provide the required proof of concept. The concentration of CO₂ slowly dropped by a total of 320 ppm. The first 17 hours or so accounted for 42% of the total drop. This drop in CO₂ concentration in the atmosphere was associated with a drop in pH of the seawater over the same period suggesting the CO₂ dissolved into the seawater as carbonic acid. This initial period of rapid CO₂ dissolution is driven by the perturbation of the buffered system. After this initial period of pH drop, there was no statistically significant variation in pH for the remainder of the experiment. The humidity reached its steady state value after this period of time as well and showed very little variation throughout the experimental period, however, it was uncorrelated with the CO₂ concentration. Temperature did not change significantly throughout the experimental period. The CO₂ concentration dropped continuously throughout the first five days of the experiment. We note that after letting the seawater sit over the weekend, the concentration approximated at steady state as shown in Table 3.

TABLE 3
Data for control experiment

| Time | CO₂ Concentration | | | Temperature |
|---|---|---|---|---|
| (hours) | (ppm) | pH | Humidity | (° C.) |
| 0 | 4170 | 7.61 | 51% | 23.2 |
| 1 | 4107 | 7.56 | 75% | 23.3 |
| 17 | 4036 | 7.26 | 97% | 21.7 |
| 19 | 4002 | 7.23 | 98% | 22.2 |
| 22 | 4021 | 7.22 | 95% | 22.7 |
| 25 | 4003 | 7.2 | 95% | 22.9 |
| 41 | 3993 | 7.13 | 97% | 23.1 |
| 43 | 3983 | 7.16 | 97% | 22.9 |
| 46 | 3978 | 7.17 | 97% | 23.2 |
| 64 | 3953 | 7.2 | 97% | 22.8 |
| 67 | 3916 | 7.16 | 97% | 22.9 |
| 71 | 3887 | 7.16 | 96% | 24 |
| 73 | 3888 | 7.18 | 97% | 23.9 |
| 90 | 3850 | 7.24 | 99% | 22.9 |
| 92 | 3797 | 7.21 | 99% | 22.9 |
| 96 | 3801 | 7.18 | 99% | 23.5 |
| 161 | 3850 | 7.27 | 99% | 21.9 |

MgOHCl Addition to Seawater: The experiment was performed by adding 36 g of MgOHCl to 2,900 g of seawater. This corresponds to an addition of 47 g of total MgOHCl material, 22% of which included anhydrous MgCl₂. This time the salinity of the seawater was monitored throughout the experiment along with pH. The starting concentration of CO₂ was 4,767 ppm, slightly higher than the previous experiment. Before the addition, the pH was around 7.59 which was approximately the same as the control experiment's starting value pH and the salinity was 15.4 ppt (parts per thousand) in agreement with tests from before and after the previous experiment as shown in Table 4.

TABLE 4
Raw data for the MgOHCl addition experiment
(ppt = parts per thousand).

| Time | CO₂ | | | Temperature | Salinity |
|---|---|---|---|---|---|
| (hours) | (ppm) | Humidity | pH | (° C.) | (ppt) |
| 0 | 4767 | 32% | 9.53 | 22.8 | 17.3 |
| 2 | 4526 | 77% | 9.56 | 22.6 | 19.4 |
| 19 | 4107 | 96% | 8.63 | 21.2 | 19.3 |
| 22 | 4014 | 96% | 8.63 | 21.2 | 18.8 |
| 25 | 3951 | 96% | 8.7 | 21.2 | 19 |
| 27 | 3890 | 97% | 8.65 | 21.5 | 19 |
| 43 | 3494 | 98% | 8.64 | 22.1 | 19.5 |
| 46 | 3397 | 98% | 8.7 | 21.9 | 19.4 |
| 49 | 3301 | 98% | 8.59 | 22.1 | 18.9 |
| 69 | 2762 | 99% | 8.4 | 21.4 | 18.7 |
| 76 | 2582 | 99% | 8.56 | 21 | 18.7 |
| 92 | 2208 | 99% | 8.52 | 21.8 | 18.7 |
| 95 | 2100 | 99% | 8.69 | 21.8 | 19.1 |
| 97 | 2022 | 99% | 8.59 | 21.8 | 18.4 |
| 99 | 1978 | 99% | 8.64 | 21.9 | 18.8 |
| 165 | 1078 | 99% | 8.48 | 22.4 | 19.5 |
| 171 | 995 | 97% | 8.52 | 22.9 | 19.1 |
| 175 | 957 | 97% | 8.64 | 23.4 | 19.3 |
| 187 | 813 | 99% | 8.58 | 22.2 | 19.3 |
| 190 | 795 | 99% | 8.58 | 22.4 | 19.2 |
| 193 | 759 | 99% | 8.66 | 22.2 | 19.1 |
| 195 | 736 | 97% | 8.69 | 22.8 | 19.6 |

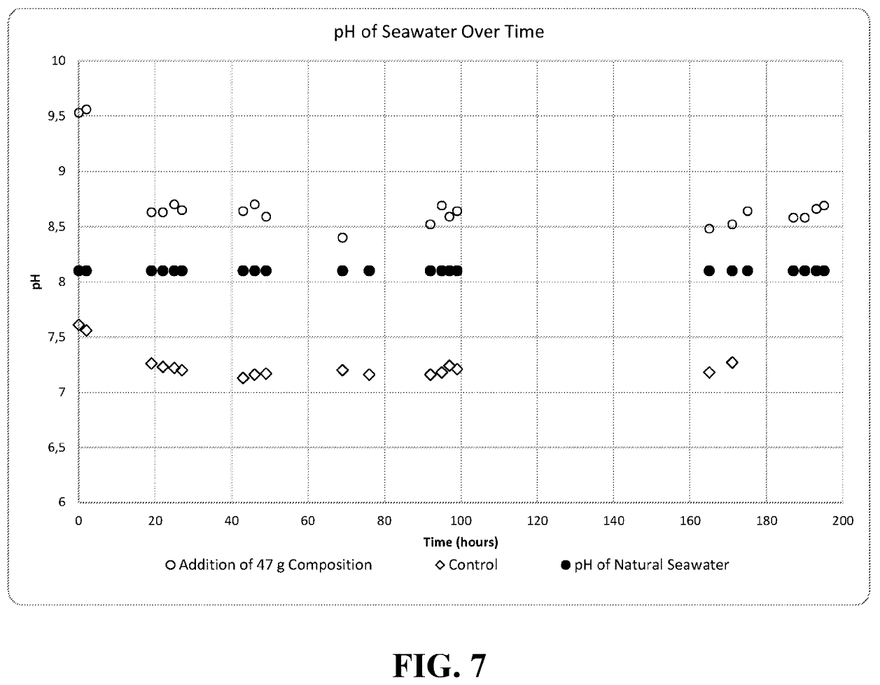

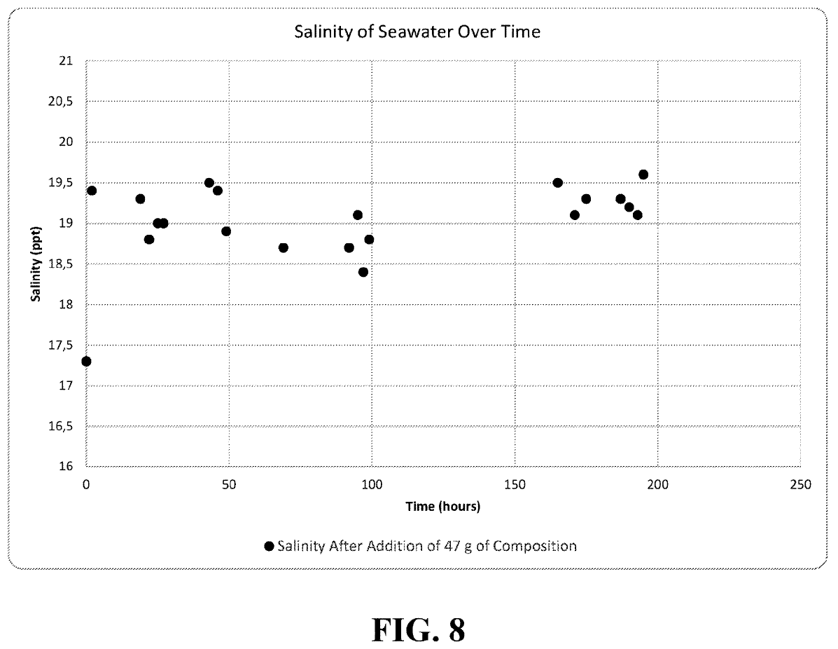

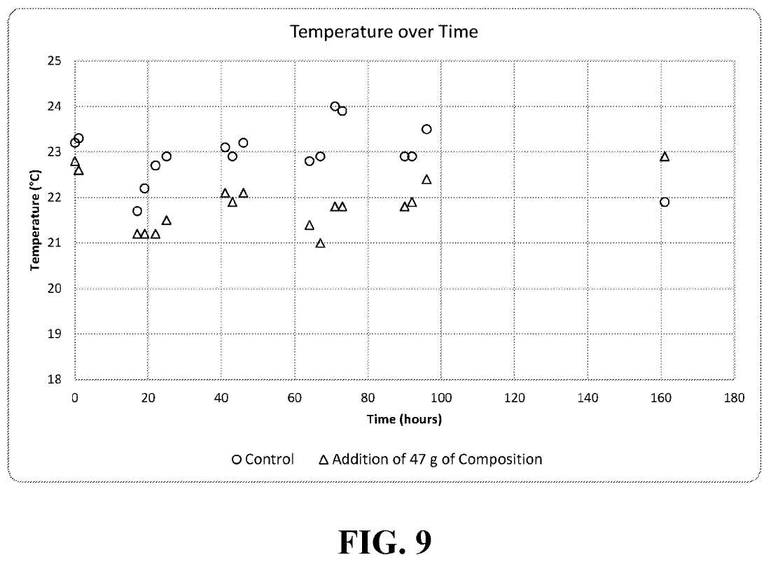

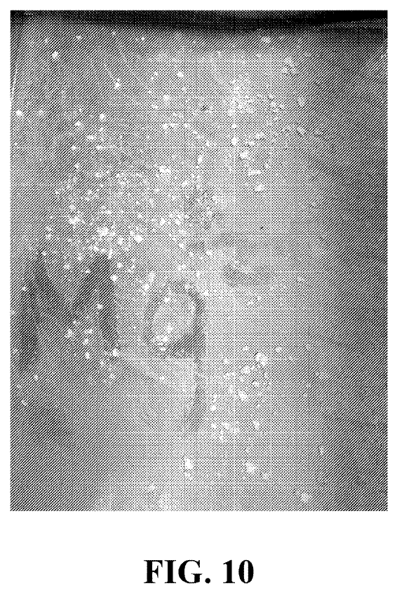

After the addition of MgOHCl, the CO₂ concentration in the atmosphere did not initially change, however a dramatic increase in pH to 9.53 was seen accompanied by a modest increase in salinity. Throughout this period, the humidity climbed towards its steady state value. Similar to the previous experiment, after 19 hours the solution reached a steady state value for pH and salinity. After this same period of time, the CO₂ concentration in the atmosphere dropped by 600 ppm, almost 3.5× the amount it dropped in the same period of time for the control experiment. It is important to note that while this period accounted for 42% of the total drop in CO₂ concentration in the control, this drop only accounted for 14% of the total drop of 4,031 ppm for the active experiment involving addition of MgOHCl. The experimental data for the seawater and atmosphere in glovebox above it are plotted in FIG. 6 for control and active experiments involving addition of MgOHCl to the seawater. FIG. 7 shows the plot of the pH changes. FIG. 8 shows the plot of the salinity changes. FIG. 9 shows the plot of the temperature during the experimental periods. The seawater pH increases and remains high while the atmosphere CO₂ concentration reduces significantly compared to a control experiment when MgOHCl was added to the seawater. The constant salinity throughout the experiment suggests the possible precipitation of carbonate minerals from the seawater when MgOHCl is added such as magnesium or calcium carbonate. A white film of particulates was observed on the bottom of the pan containing the seawater for the experiment involving MgOHCl addition, but it was not observed in the control experiment. A photo can be seen in FIG. 10, the large particles are remnants of undissolved MgOHCl chunks, the “Mg²⁺ image was made by wiping the newly formed precipitate using a gloved finger for clarity. An increase in salinity and a steady drop in pH would be expected for an accumulation of carbon in the form of carbonic acid or bicarbonate. The best explanation for this behavior of the system is that MgOHCl created units of alkalinity which allowed for the removal of CO₂ from the atmosphere of the glovebox. Data collection was stopped early for the MgOHCl experiment due to an intermixing of the lab atmosphere and the controlled atmosphere. However, the seawater was able to continue dropping the CO₂ concentration well below the standard atmospheric concentration as low as 180 ppm in the atmosphere. This extra data is presented in Table 5.

TABLE 5
Data taken from after the main collection period.

| Date | Time | CO₂ (ppm) | Temperature (° C.) |
|---|---|---|---|
| October 26 | 8:14a | 597 | 23.9 |
| — | 1:11p | 562 | 23.5 |
| — | 2:52p | 559 | 23.4 |
| October 28 | 2:45p | 332 | 21.6 |
| — | 6:15p | 326 | 22.5 |
| October 31 | 1:32p | 182 | 21.9 |

Table 6 shows the temperature dependence of a process for production of magnesium oxide in a magnesium chloride electrolyte melt. To a melt comprising 50% magnesium chloride and 50% sodium chloride was added magnesium chloride dihydrate at various temperatures. After a period of agitation, the precipitated alkalinity units, comprising magnesium oxide were separated and weighed. The ratio of magnesium oxide to anhydrous magnesium chloride produced was determined. The results are presented in Table 6, calculated to show how much mass of magnesium oxide is produced relative to the mass of magnesium metal that can be produced from the anhydrous magnesium chloride generated by dehydrating magnesium chloride dihydrate in the melt at various temperatures. FIG. 10 shows the hazy precipitate formed during the experiment, demonstrating the production of insoluble carbonates that is the mechanism for carbon sequestration caused by the processes described herein.

TABLE 6
Production of magnesium oxide in a
magnesium chloride electrolyte melt

| Temp deg. C. | 610 | 660 | 700 | 760 | 810 | 860 |
|---|---|---|---|---|---|---|
| MgO, eq. of MgOHCl:Mg | 0.46 | 0.34 | 0.24 | 0.22 | 0.12 | 0.07 |
| metal mass* ratio | | | | | | |
| MgO:Mg metal mass* | 0.92 | 0.54 | 0.55 | 0.95 | 1.03 | 0.81 |
| ratio | | | | | | |
| Conversion of MgCl₂ to | 41% | 30% | 29% | 39% | 40% | 34% |
| MgO | | | | | | |

*M metal mass is the equivalent amount of Mg metal in the electrolyte for MgCl₂ that was fed to the melt and did not hydrolyze

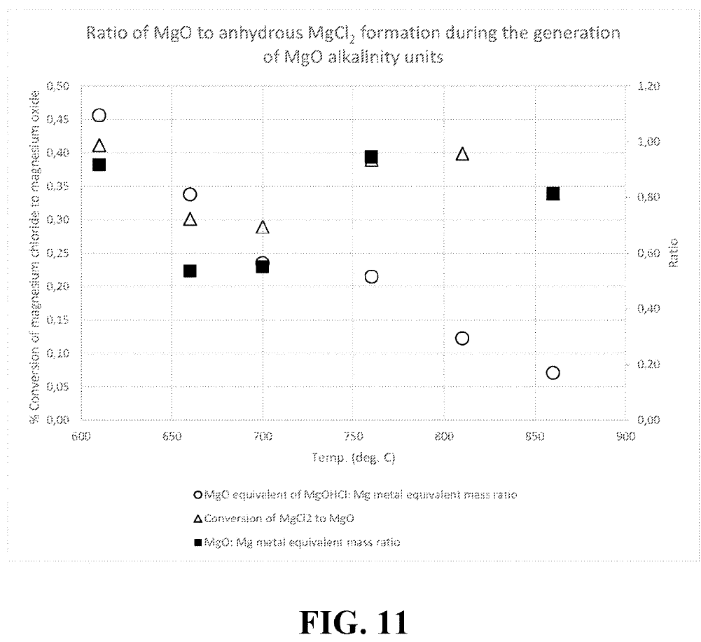

The data shown in Table 6 is plotted and shown in FIG. 11.

Any element of any embodiment may be used in any embodiment. Although the invention has been described with reference to specific embodiments, it will be understood by those skilled in the art that various changes may be made and equivalents may be substituted for elements thereof without departing from the true spirit and scope of the invention. In addition, modifications may be made without departing from the essential teachings of the invention. Identification of equivalent compositions, methods and kits are well within the skill of the ordinary practitioner and would require no more than routine experimentation, in light of the teachings of the present disclosure. Practice of the disclosure will be still more fully understood from the following examples, which are presented herein for illustration only and should not be construed as limiting the disclosure in any way.

All references cited in this specification, and their references, are incorporated by reference herein in their entirety where appropriate for teachings of additional or alternative details, features, and/or technical background.

While the disclosure has been particularly shown and described with reference to particular embodiments, it will be appreciated that variations of the above-disclosed and other features and functions, or alternatives thereof, may be desirably combined into many other different systems or applications. Also, that various presently unforeseen or unanticipated alternatives, modifications, variations or improvements therein may be subsequently made by those skilled in the art which are also intended to be encompassed by the following claims.

1. A process for increasing the alkalinity of a sea or ocean comprising:
a) subjecting a source of brine to a first thermal process, yielding a slurry or solid comprising an alkali earth salt;
b) subjecting the slurry or solid to a second thermal process yielding hydrogen chloride depleted composition and hydrogen chloride;
c) separating the hydrogen chloride depleted composition from the hydrogen chloride; and
d) introducing hydrogen chloride depleted composition into a sea or ocean, thereby increasing the total alkalinity of the sea or ocean.

2. The process of claim 1, wherein the slurry or solid comprises at least about 50% of a magnesium chloride hydrate.

3. The process of claim 1, wherein the slurry or solid comprises at least about 75% of a magnesium chloride hydrate.

4. The process of claim 1, wherein the slurry or solid comprises at least about 90% of a magnesium chloride hydrate.

5. The process of any one of claims 1 to 4, wherein the second thermal process comprises adding the solid or slurry to a melt comprising between about 35% and about 65% magnesium chloride and sodium chloride.

6. The process of claim 5, wherein the hydrogen chloride depleted composition comprises anhydrous magnesium chloride and magnesium oxide.

7. The process of claim 6, further comprising recovering the anhydrous magnesium chloride from the hydrogen chloride depleted composition before introducing it into the sea or ocean.

8. The process of claim 7, wherein the second thermal process is conducted between 500 deg. C. and 850 deg. C.

9. The process of claim 8, wherein a carbon credit is based on a calculated carbon dioxide sequestration amount resulting from the introduction of the hydrogen halide depleted composition into the sea or ocean.

10. The process for increasing the alkalinity of a sea or ocean comprising:
a) subjecting a source brine to an evaporative process, yielding a magnesium chloride hydrate;
b) subjecting the magnesium salt hydrate to a thermal process yielding magnesium hydroxychloride and hydrogen chloride;
c) separating the magnesium hydroxychloride from the hydrogen chloride;
d) contacting the magnesium hydroxychloride with a sink brine to obtain a magnesium hydroxide suspension;
e) separating the suspension to obtain the magnesium hydroxide and a magnesium chloride solution; and
f) introducing the magnesium hydroxide into a sea or ocean, thereby increasing the total alkalinity of the sea or ocean;

11. The process of claim 10, wherein a carbon credit is based on a calculated carbon dioxide sequestration amount resulting from the introduction of the magnesium hydroxide into the sea or ocean.

12. A process for increasing the alkalinity of a sea or ocean comprising:
a) contacting a source brine with calcium chloride to obtain a calcium sulfate suspension;
b) removing the calcium sulfate to obtain a magnesium chloride solution;
c) subjecting the magnesium chloride solution to an evaporative process, yielding a concentrated magnesium chloride solution;
d) subjecting the magnesium chloride solution to a thermal process yielding a solid composition comprising magnesium chloride, magnesium hydroxychloride and magnesium oxide, and hydrogen chloride;
e) separating the solid composition comprising magnesium chloride, magnesium hydroxychloride and magnesium oxide from the hydrogen chloride;
f) subjecting the solid mixture of the magnesium chloride, the magnesium hydroxychloride and the magnesium oxide to a solvent separation step to obtain the magnesium salt and a mixture of the magnesium salt hydroxychloride and magnesium oxide; and
g) introducing the magnesium hydroxychloride and magnesium oxide mixture into a sea or ocean thereby increasing the total alkalinity of the sea or ocean; and
h) converting the magnesium chloride to elemental magnesium.

13. The process of claim 12, wherein the solvent used in the solvent separation process is methanol.

14. The process of claim 12, wherein a carbon credit is claimed based on a calculated carbon dioxide sequestration amount resulting from the introduction of the magnesium hydroxychloride and magnesium oxide mixture into the sea or ocean.
